(19) United States
(12) Patent Application Publication
(10) Pub. No.: US 2014/0321432 A1
(43) Pub. Date: Oct. 30, 2014

(54) PROVIDING SERVICE CONTINUITY FOR LOCAL AREA NETWORKS

(71) Applicants: Haitao Li, Beijing (CN); Yang Liu, Beijing (CN)

(72) Inventors: Haitao Li, Beijing (CN); Yang Liu, Beijing (CN)

(21) Appl. No.: 14/364,670

(22) PCT Filed: Dec. 21, 2011
(86) PCT No.: PCT/CN2011/084344

§ 371 Date: Jun. 11, 2014

(51) Int. Cl. H04W 36/04

(52) U.S. Cl. CPC H04W 36/04; H04W 36/0088
USPC 370/331

(57) ABSTRACT

Provided are methods, corresponding apparatuses, and computer program products for providing service continuity for local area networks. A method comprises receiving, during a handover procedure between local area networks, service information that relates to one or more services supported by one or more neighbor base stations; determining, based upon the service information, which one of the one or more neighbor base stations supports an ongoing service provided by a source base station to a user equipment; and handing over the user equipment from the source base station to the determined neighbor base station. With the claimed inventions, an inter-LAN handover procedure would not impact service continuity, resulting in a more robust user experience.

### FIELD OF THE INVENTION

Embodiments of the present invention generally relate to wireless communication techniques including the 3GPP (the 3rd Generation Partnership Project) LTE technique. More particularly, embodiments of the present invention relate to methods, apparatuses, and computer program products for providing service continuity for LAN networks.

### BACKGROUND OF THE INVENTION

The 3GPP has been pursuing the goals of improving communication efficiency, lowering costs, improving services, making use of new spectrum opportunities, and achieving better integration with other open standards. These goals have been visualized into two aspects, i.e., WAN network evolution and LAN network evolution. Under the LTE standard, WAN networks are generally referred to as LTE macro networks covered by e.g., macro eNBs, and are mostly deployed and managed by operators on licensed spectrums. LAN networks, also referred to as LTE-LAN networks, consist of for example picocells or femtocells (i.e., home-eNB cells) that operate in dedicated spectrums and focus more on local area features for residential/enterprise/public hotspot use cases.

In communication architecture involving the above LTE-LAN networks, a network element, also referred to as a SN, has been located at a CN side and configured to provide support/control/maintenance functionalities to the LTE-LAN networks. An LTE-LAN BS, e.g., a home-eNB as above mentioned, has been located at a RAN network side and enables a UE to access to the LTE-LAN network. Under such architecture, the UE could be in connection with both the macro eNB and the LTE-LAN BS, which are known as “dual radio connections.” The connection with the macro eNB needs to be more stable and prudently managed such that the UE could not easily get disconnected. In contrast, the connection with the LTE-LAN BS is more endeavored to provide high speed data services for the UE in the local area.

Among a few outstanding features of the LTE-LAN network, one could be highlighted is that, due to its local area advantages, the LTE-LAN network has capabilities of providing more flexible local services than a conventional LTE macro network. Such local services may include but are not limited to LIPA, device-to-device (D2D) service, wireless display, etc. Generally speaking, the UE is entitled to “enjoy” these services only if the access has been granted by the serving LTE-LAN BS, However, not all LTE-LAN BSs necessarily provide or support a same set of services. The actual set of services that an LTE-LAN BS is capable of providing may be different according to various deploying/planning considerations and thus some LTE-LAN BSs may have no capability of providing certain local services. In this case, when a UE is traveling from an LTE-LAN BS to another LTE-LAN BS in which an inter-LAN handover procedure may occur, its ongoing local service would most likely be inaccessible due to inabilities of another LTE-LAN BS, thereby rendering service discontinuous.

The above service discontinuity could be due to the fact that the existing handover procedure has been designed mainly for the macro networks rather than for the LTE-LAN networks. In such an existing handover procedure, signal strength and network load are all-important factors when selecting a neighbor BS as a target BS for a handover and not too much attention has been paid to service continuity which, given local services, is very crucial for an inter-LAN handover. If service outage arises after the inter-LAN handover, the UE would “lose” and fail to continually “enjoy” its previous service, which is frustrating and leads to a bad user experience.

### SUMMARY OF THE INVENTION

Therefore, there is a need in the art to provide for an efficient way of performing a handover of a UE between a LAN source BS and a LAN target BS selected from one or more neighbor BSs such that the LAN target 135, subsequent to the handover, would provide the UE with the same service as the one previously provided by the LAN source BS prior to the handover. Due to provision of the same service without interruption, the local service continuity can be achieved and retained together with a good user experience.

These and other problems are generally solved or circumvented, and technical advantages are generally achieved, by embodiments of the present invention, which include methods, apparatuses, and computer program products for providing service continuity for LAN networks.

In an exemplary embodiment of the present invention, a method is provided, which comprises receiving, during a handover procedure between local area networks, service information that relates to one or more services supported by one or more neighbor base stations. The method also comprises determining, based upon the service information, which one of the one or more neighbor base stations supports an ongoing service provided by a source base station to a user equipment. Further, the method comprises handing over the user equipment from the source base station to the determined neighbor base station.

In one embodiment, the service information is received from the user equipment, and the method further comprises transmitting measurement configurations to the user equipment and receiving, from the user equipment, the service information included in a measurement report.

In another embodiment, prior to the transmitting the measurement configurations, the method further comprises determining the measurement configurations based upon a previously received measurement report without the service information.

In an additional embodiment, the configurations include information that relates to operating frequencies of the one or more neighbor base stations, a list of identifiers of the one or more neighbor base stations, or a combination of the operating frequencies and the list of identifiers of the one or more neighbor base stations.

In a further embodiment, the service information is received from a support network element, and the method further comprises receiving, from the user equipment, a measurement report that includes identifiers of the one or more neighbor base stations and retrieving, based upon the identifiers, the service information from the support network element.

In another exemplary embodiment of the present invention, a method is provided, which comprises including, during a handover procedure between local area networks, into a measurement report service information that relates to one or more services supported by one or more neighbor base stations. The method also comprises transmitting the measurement report to a source base station.

In another embodiment, the method further comprises prior to the including, obtaining, based upon measurement configurations received from the source base station, the service information from the one or more neighbor base stations.

In an additional exemplary embodiment of the present invention, an apparatus is provided, which comprises means for receiving, during a handover procedure between local area networks, service information that relates to one or more services supported by one or more neighbor base stations. The apparatus also comprises means for determining, based upon the service information, which one of the one or more neighbor base stations supports an ongoing service provided by a source base station to a user equipment. In addition, the apparatus comprises means for handing over the user equipment from the source base station to the determined neighbor base station.

In one exemplary embodiment of the present invention, an apparatus is provided, which comprises means for including, during a handover procedure between local area networks, into a measurement report service information that relates to one or more services supported by one or more neighbor base stations. The apparatus also comprises means for transmitting the measurement report to a source base station.

In one exemplary embodiment of the present invention, an apparatus is provided, which comprises at least one processor and at least one memory including computer program code. The memory and the computer program code are configured to cause the apparatus to receive, during a handover procedure between local area networks, service information that relates to one or more services supported by one or more neighbor base stations. The memory and the computer program code are also configured to cause the apparatus to determine, based upon the service information, which one of the one or more neighbor base stations supports an ongoing service provided by a source base station to a user equipment. Further, the memory and the computer program code are also configured to cause the apparatus to hand over the user equipment from the source base station to the determined neighbor base station.

In another exemplary embodiment of the present invention, an apparatus is provided, which comprises at least one processor and at least one memory including computer program code. The memory and the computer program code are configured to cause the apparatus to include, during a handover procedure between local area networks, into a measurement report service information that relates to one or more services supported by one or more neighbor base stations. The memory and the computer program code are also configured to cause the apparatus to transmit the measurement report to a source base station.

In one exemplary embodiment of the present invention, a computer program product is provided, which, comprises at least one computer readable storage medium having a computer readable program code portion stored thereon. The computer readable program code portion comprises program code instructions for receiving, during a handover procedure between local area networks, service information that relates to one or more services supported by one or more neighbor base stations. The computer readable program code portion also comprises program code instructions for determining, based upon the service information, which one of the one or more neighbor base stations supports an ongoing service provided by a source base station to a user equipment. Further, the computer readable program code portion also comprises program code instructions for handing over the user equipment from the source base station to the determined neighbor base station.

In an additional exemplary embodiment of the present invention, a computer program product is provided, which, comprises at least one computer readable storage medium having a computer readable program code portion stored thereon. The computer readable program code portion comprises program code instructions for including, during a handover procedure between local area networks, into a measurement report service information that relates to one or more services supported by one or more neighbor base stations. The computer readable program code portion also comprises program code instructions for transmitting the measurement report to a source base station.

According to certain embodiments of the present invention, by taking into consideration service capabilities of one or more neighbor base stations before performance of the handover, the source base station is capable of handing over the use equipment to a proper target base station that is able to support the same service as the ongoing service provided by the source base station. Consequently, the user equipment would not experience any service discontinuity and a more robust user experience can be accomplished.

Other features and advantages of the embodiments of the present invention will also be understood from the following description of specific embodiments when read in conjunction with the accompanying drawings, which illustrate, by way of example, the principles of embodiments of the present invention.

### BRIEF DESCRIPTION OF THE DRAWINGS

The embodiments of the invention that are presented in the sense of examples and their advantages are explained in greater detail below with reference to the accompanying drawings, in which:

FIG. 1 is a flow chart schematically illustrating a method for providing service continuity for LAN networks from a source BS perspective according to an embodiment of the present invention;

FIG. 2 is a flow chart schematically illustrating a method for providing service continuity for LAN networks from a UE perspective according to another embodiment of the present invention;

FIG. 3 is a flow chart schematically illustrating a method for providing service continuity for LAN networks according to an embodiment of the present invention;

FIG. 4 is a flow chart schematically illustrating a method for providing service continuity for LAN networks according to another embodiment of the present invention; and

FIG. 5 is a schematic block diagram of a BS and a UE that are suitable for use in practicing the exemplary embodiments of the present invention.

### DETAILED DESCRIPTION OF EMBODIMENTS

Embodiments of the present invention propose an efficient mechanism of performing a handover from a source BS to a target BS (i.e., a determined neighbor BS as discussed later) in LTE-LAN networks such that service continuity for a served UE could be achieved. During such a handover, the source BS would use service information of one or more neighbor BSs in deciding which the neighbor BS is a proper target BS. This can be accomplished by various embodiments of the present invention. In an embodiment, the source BS, based upon the UE's measurement report, inquires service information of the one or more neighbor BSs by retrieving a database hosted by a SN and located at the SN side. In another embodiment, the UE receives the service information of the one or more neighbor BSs by using an autonomous gap and then transmits the service information to the source BS via a measurement report.

Before detailed description of various embodiments of the present invention, it should be noted that the acronyms BS, NB, and eNB may refer generally to equipment providing wireless network interfaces in a cellular wireless system, and thus will be used interchangeably herein.

Embodiments of the present invention will be described in detail as below.

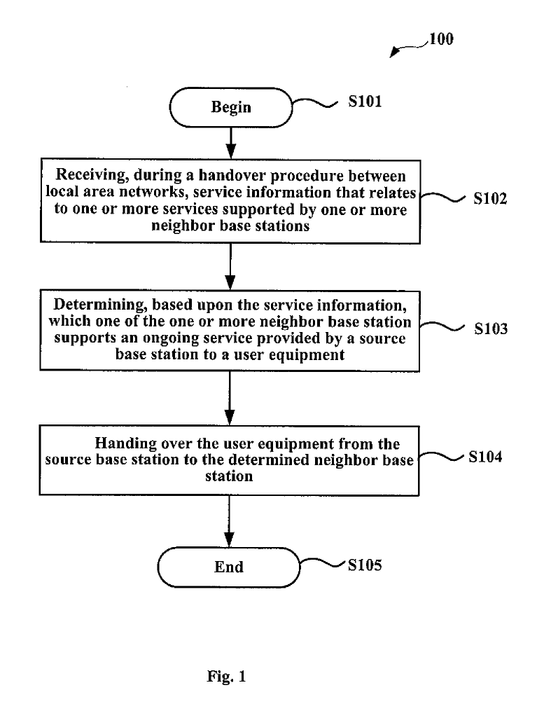

FIG. 1 is a flow chart schematically illustrating a method 100 for providing service continuity for LAN networks from a source BS perspective according to an embodiment of the present invention. As illustrated in FIG. 1, the method 100 begins at step S101 and proceeds to step S102, at which the method 100 receives, during a handover procedure between LAN networks, service information that relates to one or more services supported by one or more neighbor BSs.

Although not illustrated in FIG. 1, in some embodiments, the method 100 receiving the service information at step S102 receives the service information from the UE, and the method 100 further transmits measurement configurations to the UE and receives, from the UE, the service information included in a measurement report. In some embodiments, prior to transmitting the measurement configurations, the method 100 further determines the measurement configurations based upon a previously received measurement report without the service information. In some embodiments, the method 100 receiving the service information at step S102 receives the service information from a SN, and the method 100 further receives, from the UE, a measurement report that includes identifiers of one or more neighbor BSs, and retrieves, based upon the identifiers, the service information from the SN. The configurations, as pointed out above, may include information that relates to operating frequencies of the one or more neighbor BSs, a list of identifiers of the one or more neighbor BSs, or a combination of the operating frequencies and the list of identifiers of the one or more neighbor BSs. For example, the identifier of a neighbor BS may be a PCI.

Upon successful receipt of the above service information, the method 100 proceeds to step S103, at which the method 100 determines, based upon the service information, which one of the one or more neighbor BSs supports an ongoing service provided by a source BS to a UE. For example, assuming that the UE currently has access to a wireless display service as provided by the source BS and the received service information indicates that the service as provided by one of the neighbor BSs matches the wireless display service, then it can be determined that this neighbor BS is the one that supports the ongoing service.

Afterwards, the method 100 advances to step S104, at which the method 100 hands over the UE from the source BS to the determined neighbor BS (i.e., the target BS). As discussed above, because the determined neighbor BS supports the ongoing service (or service type), the UE can be smoothly and seamlessly handed over to the target BS without interruption of the ongoing service, even though the service is now provided by the target BS in place of the source BS. In some embodiments, if more than one neighbor BS is present and their supportive services match the ongoing service, then the source BS may further select one of them as a target BS based upon other applicable criterions, such as signal strength or quality (e.g., RSRP or RSRQ value) or sequence of responding to a handover request as initiated by the source BS. If the service as supported by the neighbor BS does not match the ongoing service, then the source BS would abandon or exclude this neighbor BS during performance of the handover.

Finally, the method 100 ends at step S105.

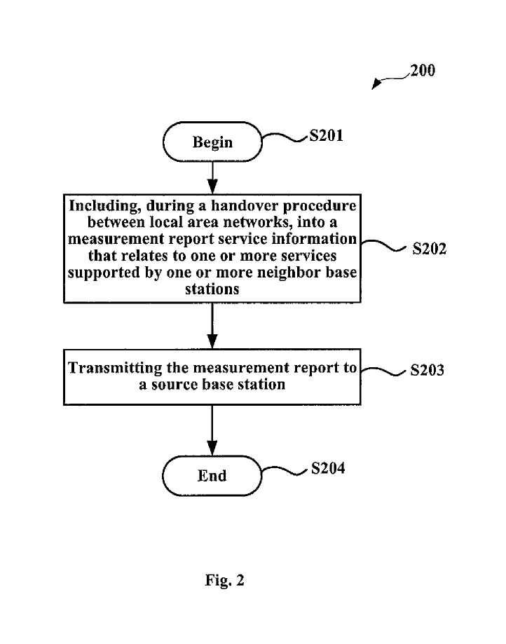

FIG. 2 is a flow chart schematically illustrating a method for providing service continuity for LAN networks from a UE perspective according to another embodiment of the present invention. As illustrated in FIG. 2, the method 200 begins at step S201 and proceeds to step S202, at which the method 200 includes, during a handover procedure between LAN networks, into a measurement report service information that relates to one or more services supported by one or more neighbor BSs. In other words, the service information has been encapsulated into the measurement report to be supplied to the source BS.

After including the service information into the measurement report, the method 200 proceeds to step S203, at which the method 200 transmits the measurement report to a source BS. Finally, the method 200 ends at step S204.

With the methods 100 and 200 as illustrated and discussed above, the measurement report according to embodiments of the present invention can be configured in a manner that provides a good basis to support a correct cell selection decision and facilitates service continuity. Further, by pre-determining whether the target BS supports the ongoing service, service outage that may arise as a result of a handover would be eliminated. Additionally, it should be noted that details regarding how to perform the handover are omitted herein so as to avoid unnecessarily obscuring the embodiments of the present invention.

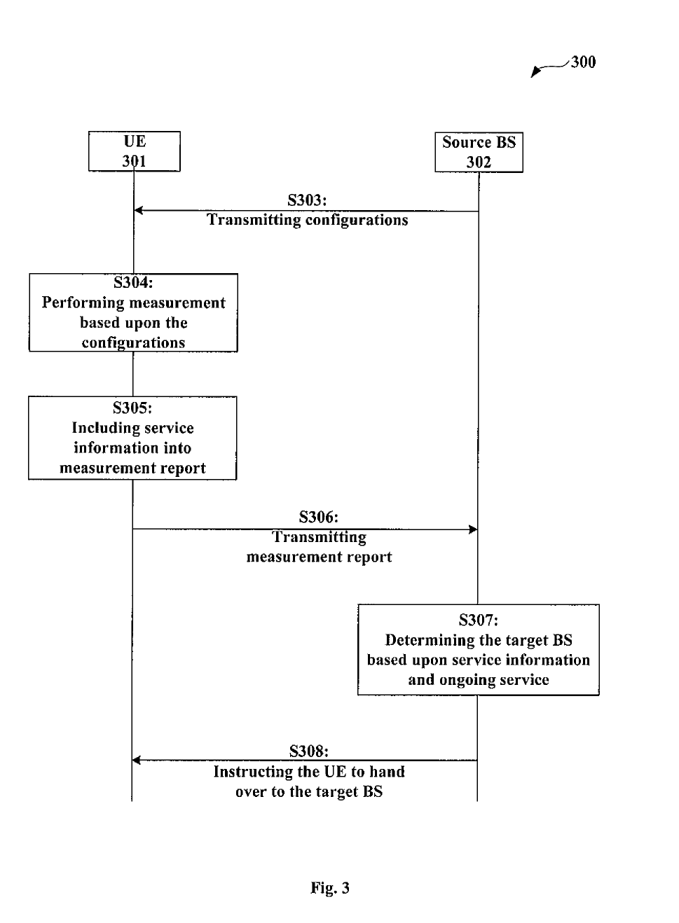

FIG. 3 is a flow chart schematically illustrating a method 300 for providing service continuity for LAN networks according to an embodiment of the present invention. As illustrated in FIG. 3, the method 300 begins at step S303, wherein the source BS 302 transmits to the UE 301 measurement configurations which will be used subsequently by the UE 301 in generating a measurement report. As discussed before, the contents of the measurement configurations may vary dependent on frequencies at which the LAN networks have been allocated or operating. In a case in which the LAN networks have been deployed in their own dedicated operating frequencies, the source BS 302 may signal these dedicated operating frequencies to the UE 301. In another case in which the LAN networks have been deployed in LTE frequencies, i.e., sharing of frequencies with macro networks, the source BS 302 may signal to the UE 301 PCI split information together with the operating frequencies with respect to the neighbor BSs such that the UE 301 is able to readily identify which neighbor BSs should be measured.

Subsequent to transmitting the measurement configurations to the UE 301, the method 300 advances to step S304, at which the UE 301, based upon the measurement configurations, performs measurements on one or more neighbor BSs. During such measurements, the UE 301 receives, by using an autonomous gap or a separate RF chain, SIBs broadcasted or available from the one or more neighbor BSs, wherein the SIB includes service information of the respective neighbor BS.

After obtaining the service information, the method 300 proceeds to step S305, at which the UE 301 includes the service information into a measurement report. Upon triggers of certain events (e.g., A3 event as known to those skilled in the art), the UE 301, at step S306, transmits the measurement report to the source BS 302. In addition to the service information, the measurement report may also include information elements regarding the PCI and RSRP/RSRQ value of the respective neighbor BS.

Upon receipt of the measurement report from the UE 301, the method 300 advances to step S307, at which the source BS determines, based upon the received service information and the ongoing service, which one of the neighbor BSs is suited for a handover, resulting in a target BS. According to various embodiments of the present invention, in order to keep service continuous, the source BS 302 takes into account the ongoing service of the UE 301 and the received service information in determining a proper and final target BS. For example, the source BS 302 may compare the received service information with the ongoing service and select one of the neighbor BSs that matches or supports the ongoing service as a final or intended target BS. This way, the service that the UE 301 currently accesses to could be kept continuous and the user experience would not be impacted or even be improved through the above handover.

Subsequent to the determining the target BS at step S307, the method 300 proceeds to step S308, at which the source BS 302 instructs the UE 301 to hand over to the target BS. By implementation of the method 300, the presence of service discontinuity would be significantly decreased.

Although not illustrated in FIG. 3, the method 300, prior to transmitting the measurement configurations of the measurement report, may determine the measurement configurations based upon a previously received measurement report which no service information is present. For example, based upon the PCI split or RSRP/RSRQ information included in the previously received measurement report, the source BS 302 may determine which BSs are neighbor LTE-LAN BSs with high likelihood of being the target BS. Then, the source BS 302 may indicate or instruct, via the measurement configurations, the UE 301 to perform measurements on these neighbor BSs, as discussed above in connection with the step S304.

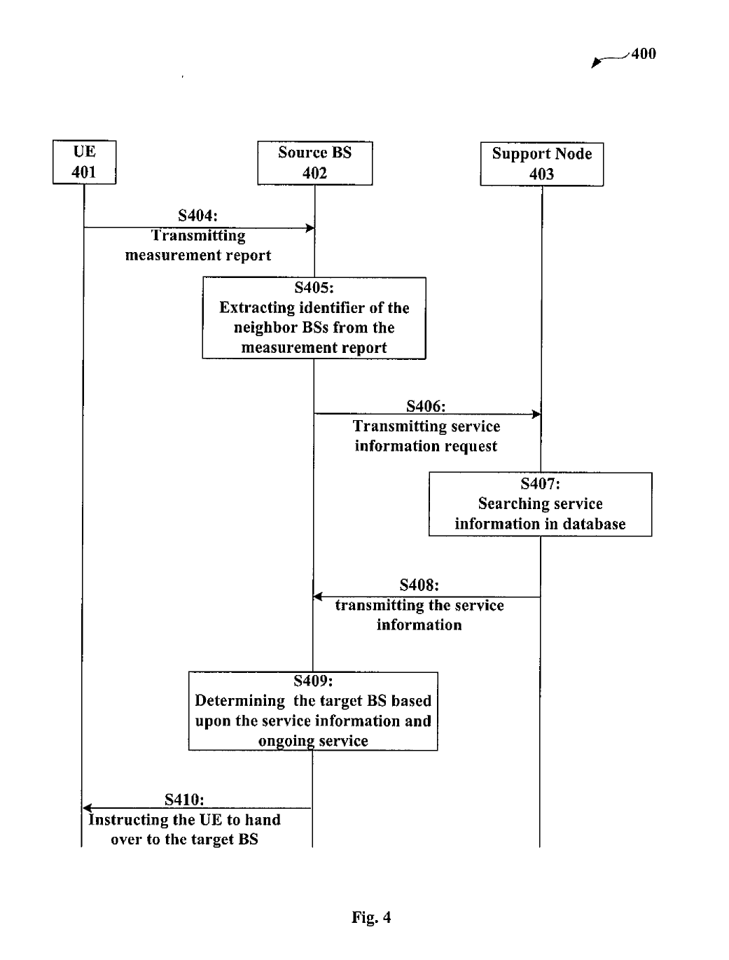

FIG. 4 is a flow chart schematically illustrating a method 400 for providing service continuity for LAN networks according to another embodiment of the present invention. As illustrated in FIG. 4, the method 400 begins at step S404, wherein the UE 401 transmits to the source BS 402 a normal measurement report which may, absent any service information, include PCI information (i.e., a list of PCIs) of the neighbor BSs, operating frequencies, and additional RSRP/RSRQ values. Upon receiving the normal measurement report, the method 400 proceeds to step S405, at which the source BS 402 extracts or derives identifiers of the these neighbor BSs based upon the PCIs within the measurement report. The identifier herein refers to a cell ID that corresponds to the PCI. Then, at step S406, the source BS 402 transmits to the SN 403 a service information request that includes the identifiers of the neighbor BSs.

Upon receipt of the service information request, the method 400 advances to step S407, at which the SN (also referred to as “support network element”) 403 searches its hosted database for service information regarding the neighbor BSs at issue. Once the service information has been uncovered, the SN 403, at step S408, transmits the service information to the source BS 402 as a response to the service information request. In other words, based upon knowledge of frequencies or PCI information of the neighbor BSs, the source BS 402 may retrieve the service information from the database that has stored service information and has been hosted by the SN. The transmitting at steps S406 and S408 or the retrieving can be implemented via a direct interface between the source BS and the SN, or via an interface between a LAN network and a macro network and then via an interface between the macro network and the SN, or via any other suitable network nodes.

All things being equal, the method 400 advances to step S409, at which the source BS 402 determines, based upon the ongoing service of the UE 401 and the received service information, which one of the neighbor BSs is a potential target BS that is suitable for handover, i.e., supporting and not interrupting the ongoing service. In an embodiment, the source BS 402 may determine whether the potential target BS supports the ongoing service based upon whether the service information matches the ongoing service. If the potential target BS supports the ongoing service, then the source BS 402 may regard it as a final target BS. In another embodiment, if more than one potential target BS supports the ongoing service, then the source BS 402 may select one of them as the final target BS based upon some (existing) criterion or algorithms. For example, the potential target BS that first responds to the handover request as initiated by the source BS 402 would be selected as the final or intended target BS. Finally, the source BS 402 instructs, at step S410, the UE 401 to hand over to the selected target BS.

The foregoing has discussed, in connection with FIGS. 3 and 4, the methods 300 and 400 which may involve further implemental details or variants of the methods 100 and 200; however, the present invention is not limited thereto. Further, it should be noted herein that the steps as illustrated FIGS. 3 and 4 are only examples and are not restrictive to the present invention. Those skilled in the art, after reading the present specification, can change these steps, for example, by combining or adding certain steps, so as to meet different application demands.

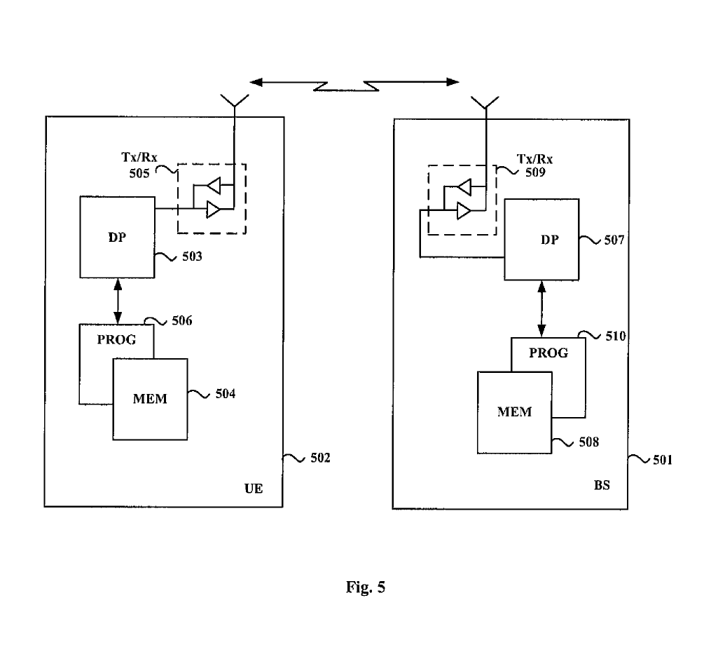

FIG. 5 illustrates a simplified block diagram of a BS 501 and a UE 502 that are suitable for use in practicing the exemplary embodiments of the present invention. In FIG. 5, a wireless network is adapted for communication with the UE 502, also referred to as the LTE-LAN UE, via the BS 501, also referred to as the LTE-LAN BS (or eNB). The UE 502 includes a data processor (DP) 503, a memory (MEM) 504 coupled to the DP 503, and a suitable RF transmitter TX and receiver RX 505 (which need not to be implemented in a same component) coupled to the DP 503. The MEM 504 stores a program (PROG) 506. The TX/RX 505 is for bidirectional wireless communications with the BS 501. Note that the TX/RX 505 has at least one antenna to facilitate communication; multiple antennas may be employed for multiple-input multiple-output MIMO communications in which case the UE 502 may have multiple TXs and/or RXs.

The BS 501 includes a data processor (DP) 507, a memory (MEM) 508 coupled to the DP 507, and a suitable RF transmitter TX and receiver RX 509 coupled to the DP 507. The MEM 508 stores a program (PROG) 510. The TX/RX 509 is for bidirectional wireless communications with the UE 502. Note that the TX/RX 509 has at least one antenna to facilitate communication, though in practice a BS will typically have several. The BS 501 may be coupled via a data path to one or more external networks or systems, such as the Internet, for example.

At least one of the PROGs 506 and 510 is assumed to include program instructions that, when executed by the associated DPs 503 and 507, enable the UE 502 and BS 501 to operate in accordance with the exemplary embodiments of the present invention, as discussed herein with the methods 100, 200, 300, and 400.

In general, the various embodiments of the UE 502 can include, but are not limited to, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of the present invention may be implemented by computer software executable by one or more of the DPs 503, 507 of the UE 502 and the BS 501, or by hardware, or by a combination of software and hardware.

The MEMs 504 and 508 may be of any type suitable to the local technical environment and may be implemented using any suitable data storage technology, such as semiconductor based memory devices, magnetic memory devices and systems, optical memory devices and systems, fixed memory and removable memory, as non-limiting examples. While only one MEM is shown in the BS 501 or UE 502, there may be several physically distinct memory units in the BS 501 or UE 502. The DPs 503 and 507 may be of any type suitable to the local technical environment, and may include one or more of general purpose computers, special purpose computers, microprocessors, digital signal processors (DSPs) and processors based on multicore processor architecture, as non-limiting examples. Either or both of the UE 502 and the BS 501 may have multiple processors, such as for example an application specific integrated circuit chip that is slaved in time to a clock which synchronizes the main processor.

Exemplary embodiments of the present invention have been described above with reference to block diagrams and flowchart illustrations of methods, apparatuses (i.e., systems). It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

The foregoing computer program instructions can be, for example, sub-routines and/or functions. A computer program product in one embodiment of the invention comprises at least one computer readable storage medium, on which the foregoing computer program instructions are stored. The computer readable storage medium can be, for example, an optical compact disk or an electronic memory device like a RAM (random access memory) or a ROM (read only memory).

Various abbreviations that appear in the specification and/or in the drawing figures are defined as below:
BS Base Station
CN Core Network
LTE Long Term Evolution
NB Node B
eNB evolved Node B
LAN Local Area Network
LIPA Local Internet Protocol Access
LAN Local Area Network
PCI Physical Cell Identifier
SIB System Information Block
SN Support Node
SI System Information
RRC Radio Resource Control
RF Radio Frequency
RSRP Reference Signal Receiving Power
RSRQ Reference Signal Received Quality
WAN Wide Area Network
RAN Radio Access Network
UE User Equipment

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

1-18. (canceled)

19. A method, comprising:
receiving, during a handover procedure between local area networks, service information that relates to one or more services supported by one or more neighbor base stations;
determining, based upon the service information, which one of the one or more neighbor base stations supports an ongoing service provided by a source base station to a user equipment; and
handing over the user equipment from the source base station to the determined neighbor base station.

20. The method as recited in claim 19, wherein the service information is received from the user equipment, and the method further comprises:
transmitting measurement configurations to the user equipment; and
receiving, from the user equipment, the service information included in a measurement report.

21. The method as recited in claim 20, wherein prior to the transmitting the measurement configurations, the method further comprises:
determining the measurement configurations based upon a previously received measurement report without the service information.

22. The method as recited in claim 19, wherein the configurations include information that relates to operating frequencies of the one or more neighbor base stations, a list of identifiers of the one or more neighbor base stations, or a combination of the operating frequencies and the list of identifiers of the one or more neighbor base stations.

23. The method as recited in claim 19, wherein the service information is received from a support network element, and the method further comprises:
receiving, from the user equipment, a measurement report that includes identifiers of the one or more neighbor base stations; and
retrieving, based upon the identifiers, the service information from the support network element.

24. An apparatus, comprising:
at least one processor; and
at least one memory including computer program code,
the at least one memory and computer program code configured to, with the at least one processor, cause the apparatus to:
receive, during a handover procedure between local area networks, service information that relates to one or more services supported by one or more neighbor base stations;
determine, based upon the service information, which one of the one or more neighbor base stations supports an ongoing service provided by a source base station to a user equipment; and
hand over the user equipment from the source base station to the determined neighbor base station.

25. The apparatus as recited in claim 24, wherein the service information is received from the user equipment, and the apparatus is further caused to:
transmit measurement configurations to the user equipment; and
receive, from the user equipment, the service information included in a measurement report.

26. The apparatus as recited in claim 25, wherein prior to the transmitting measurement configurations, the apparatus is further caused to:
Determine the measurement configurations based upon a previously received measurement report without the service information.

27. The apparatus as recited in claim 24, wherein the configurations include information that relates to operating frequencies of the one or more neighbor base stations, a list of identifiers of the one or more neighbor base stations, or a combination of the operating frequencies and the list of identifiers of the one or more neighbor base stations.

28. The apparatus as recited in claim 24, wherein the service information is received from a support network element, and the apparatus is further caused to:
receive, from the user equipment, a measurement report that includes identifiers of the one or more neighbor base stations; and
retrieve, based upon the identifiers, the service information from the support network element.

29. An apparatus, comprising:
at least one processor; and
at least one memory including computer program code,
the at least one memory and computer program code configured to, with the at least one processor, cause the apparatus to:
include, during a handover procedure between local area networks, into a measurement report service information that relates to one or more services supported by one or more neighbor base stations; and
transmit the measurement report to a source base station.

30. The apparatus as recited in claim 29, wherein prior to the including, the apparatus is further causes to obtain, based upon measurement configurations received from the source base station, the service information from the one or more neighbor base stations.
